(19) United States
(12) Patent Application Publication
(10) Pub. No.: US 2016/0307207 A1
(43) Pub. Date: Oct. 20, 2016

(54) Analytical Functionality Selecting Relevant Market Research Data for Global Reporting

(71) Applicants: Hergen BUSCH, Heidelberg (DE); Dirk KOELLING, Hamburg (DE); Julia DEUTSCH, Heidelberg (DE)

(72) Inventors: Hergen BUSCH, Heidelberg (DE); Dirk KOELLING, Hamburg (DE); Julia DEUTSCH, Heidelberg (DE)

(21) Appl. No.: 14/687,770

(22) Filed: Apr. 15, 2015

(51) Int. Cl. G06Q 30/02

(52) U.S. Cl. CPC G06Q 30/0201

(57) ABSTRACT

Embodiments provide methods and systems configured to consolidate market research data from a plurality of sources (e.g., regional providers) into a single data warehouse suited for global reporting purposes. Accordingly an engine is provided in communication with a plurality of underlying databases each comprising market research data. The databases comprises a time dimension, a market dimension, and a product dimension. The engine aggregates data of the individual market research databases into a consolidated database, by first identifying a pre-aggregated market total. Next, the engine selects and identifies single individual products relevant to the aggregated market research data. Finally, the engine checks that the sum of the selected products of the previous step is within a tolerance level of the pre-aggregated market total of the initial step. If the check fails, in an iterative manner the engine returns to alter the selected relevant products and performs the check step again.

### BACKGROUND

Unless otherwise indicated herein, the approaches described in this section are not prior art to the claims in this application and are not admitted to be prior art by inclusion in this section.

Embodiments relate to data handling, and in particular to analytical functionality selecting relevant market research data for global reporting.

There exist a number of different third-party providers of market research data. One example of such a source for market research data is NIELSEN HOLDINGS NV.

Market research data is typically supplied from a source in database form, purchased by the regional or local departments of a manufacturer. This market research data is frequently used for detailed local market share analysis (local reporting) for the region, countries, and product segments for which the local department is responsible.

External source databases provided by a third party (e.g., NIELSEN) includes data pre-aggregated on each hierarchy level along product, geography, and time dimensions. Thus within an external database, each level between the total and the item level thus exists as an aggregated value in the database. Thus a user may not simply sum all lines in order to perform an analysis.

Also, the organization of market research data can vary as between different available sources. Thus databases offered by various third-party providers of market research can differ according to source, markets/countries, product segments, and/or time series as well. The market research data of such databases thus reflects a heterogeneous data model.

Apart from the local aspect of market research analysis, manufacturers may also have other departments (e.g., category management, international marketing) that seek to analyze market research data across product segments and/or national boundaries (global reporting). For a company with a global marketing department interested in such global reporting, it may be desired to unify the various available market research databases in order to make them reportable.

A challenge, therefore, is to select for each database that master data and transactional data relevant for global reporting. Thus it may be desirable to consolidate various market research databases into a common, global data model.

### SUMMARY

Embodiments provide methods and systems configured to consolidate market research data from a plurality of sources (e.g., regional providers) into a single data warehouse suited for global reporting purposes. Accordingly an engine is provided in communication with a plurality of underlying databases each comprising market research data. The databases comprises a time dimension, a market dimension, and a product dimension. The engine aggregates data of the individual market research databases into a consolidated database, by first identifying a pre-aggregated market total. Next, the engine selects and identifies single individual products relevant to the aggregated market research data. Finally, the engine checks that the sum of the selected products of the previous step is within a tolerance level of the pre-aggregated market total of the initial step. If the check fails, in an iterative manner the engine returns to alter the selected relevant products and performs the check step again.

An embodiment of a computer-implemented method comprises an engine receiving first market research data from a first source, and receiving second market research data from second source. The engine calculates a pre-aggregated market total from the first market research data and the second market research data. The engine generates from the first market data and the second market data, a first aggregated market total comprising a first selected product in the first market research data and the second market research data. The engine determines whether the first aggregated market total is within a tolerance of the pre-aggregated market total. The engine displays to a user, a result of the determining. Where the aggregated market total is within the tolerance, a global report is displayed to the user. Where the aggregated market total is not within the tolerance, the engine generates from the first market data and the second market data, a second aggregated market total comprising a second selected product, and the engine determines whether the second aggregated market total is within the tolerance.

A non-transitory computer readable storage medium embodies a computer program for performing a method comprising an engine receiving first market research data from a first source, and receiving second market research data from second source. The engine calculates a pre-aggregated market total from the first market research data and the second market research data. The engine generates from the first market data and the second market data according to a time granularity, a first aggregated market total comprising a first selected product in the first market research data and the second market research data. The engine determines whether the first aggregated market total is within a tolerance of the pre-aggregated market total. The engine displays to a user, a result of the determining. Where the aggregated market total is within the tolerance, a global report is displayed to the user. Where the aggregated market total is not within the tolerance, the engine generates from the first market data and the second market data, a second aggregated market total comprising a second selected product, and the engine determines whether the second aggregated market total is within the tolerance.

An embodiment of a computer system comprises one or more processors and a software program executable on said computer system. The software program is configured to cause an engine to receive first market research data from a first source, and receive second market research data from second source. The software program is configured to calculate a pre-aggregated market total from the first market research data and the second market research data. The software program is configured to generate from the first market data and the second market data, a first aggregated market total comprising a first selected product of the first market research data and the second market research data. The software program is configured to determine whether the first aggregated market total is within a tolerance of the pre-aggregated market total. The software program is configured to display to a user, a result of the determining. Where the aggregated market total is within the tolerance, the software program is configured to display a global report to the user. Where the aggregated market total is not within the tolerance, the software program is configured to generate from the first market data and the second market data, a second aggregated market total comprising at least a second selected product, and to determine whether the second aggregated market total is within the tolerance.

In some embodiments the second aggregated market total further comprises the first selected product.

In particular embodiments the second aggregated market total does not comprise the second selected product.

According to various embodiments the pre-aggregated market total and the first aggregated market total are calculated according to a common time granularity input by the user.

In some embodiments the tolerance is input to the engine from the user.

According to particular embodiments the pre-aggregated market total and the first aggregated market total are calculated according to a market segment of the first market research data.

In certain embodiments the first selected product is from a product hierarchy of the first market research data.

According to various embodiments the global report includes the product hierarchy.

Some embodiments further comprise displaying the global report when the second aggregated market total is within the tolerance.

Particular embodiments further comprise calculating a third aggregated market total comprising a third product where the second aggregated market total is not within the tolerance.

The following detailed description and accompanying drawings provide a better understanding of the nature and advantages of embodiments.

### BRIEF DESCRIPTION OF THE DRAWINGS

FIG. 1 is a simplified view depicting the dimensions of a market research database structure.

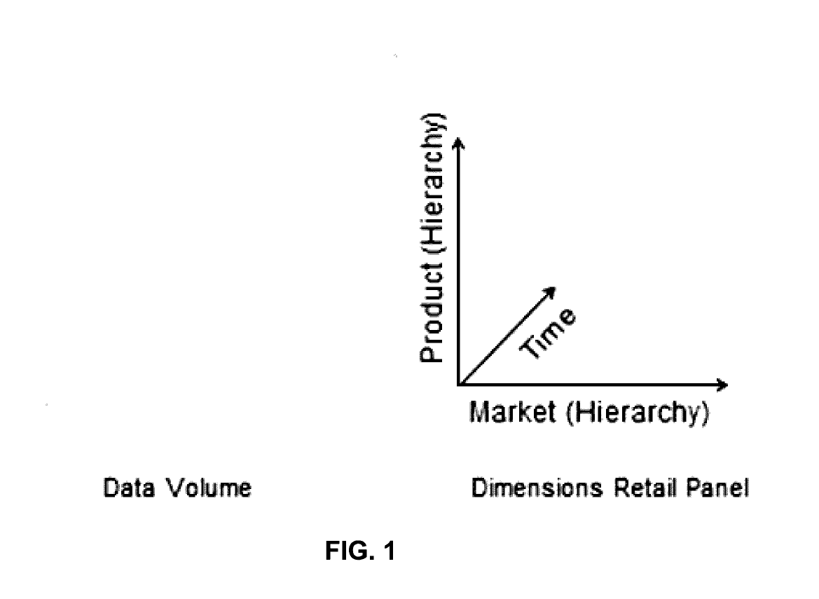

FIG. 2 is a simplified view of an embodiment of a data consolidation system according to an embodiment.

FIG. 3 is a simplified flow diagram of a process according to an embodiment.

FIG. 4 is a simplified view showing the selection of granularity for the time dimension of a global market research database structure.

FIG. 5 is a simplified view showing the selection of markets for a global market research database structure.

FIG. 6 is a simplified view showing the selection of products for a global market research database structure.

FIG. 7 is a simplified view showing checking of values within a tolerance level.

FIG. 8 shows an overall process flow for data consolidation according to an example.

FIG. 8A is a screenshot showing selection of a pre-aggregated market total according to the example.

FIG. 8B is a screenshot showing definition of a product hierarchy according to the example.

FIG. 8C is a screenshot showing definition of a location according to the example.

FIG. 9 is a screenshot showing product consolidation definition according to the example.

FIG. 9A is a screenshot showing comparison to a hierarchy level according to the example.

FIG. 9B is a screenshot showing detailed data for a particular level according to the example.

FIG. 9C is a screenshot displaying source data by level according to the example.

FIG. 10 is a screenshot comparing a market total with aggregated totals according to the example.

FIG. 10A is a screenshot showing a threshold range defined in transaction before data extraction to global reporting according to the example.

FIG. 11 illustrates hardware of a special purpose computing machine configured to perform data consolidation according to an embodiment.

FIG. 12 illustrates an example of a computer system.

### DETAILED DESCRIPTION

Described herein are systems and methods for performing consolidation of market research data for global reporting according to various embodiments. In the following description, for purposes of explanation, numerous examples and specific details are set forth in order to provide a thorough understanding of the present invention. It will be evident, however, to one skilled in the art that embodiments of the present invention as defined by the claims may include some or all of the features in these examples alone or in combination with other features described below, and may further include modifications and equivalents of the features and concepts described herein.

Providers of market research data may compile a wide variety of details within a single database. Such database data may be structured according to the following three (3) hierarchical dimensions:
Geography/Market;
Product;
Time.

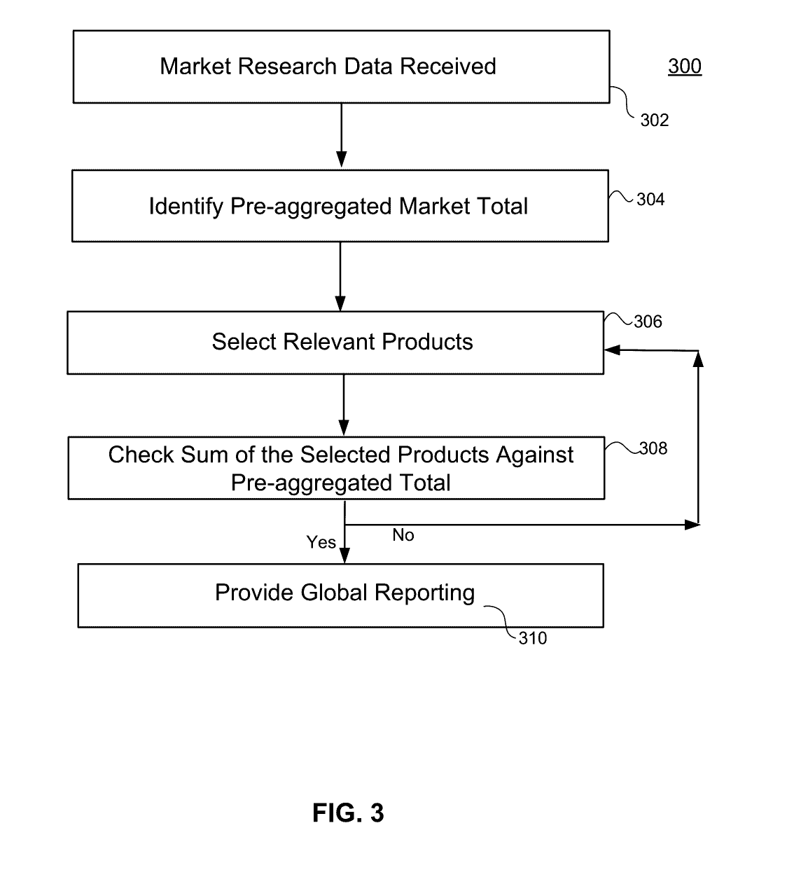

Accordingly, FIG. 3 is a simplified view depicting the dimensional structure of a market research database.

The market dimension may organized according to market breakdown structures. Examples can include but are not limited to region, sales channel, and key accounts. Markets are defined by the leading market research institutes. Sometimes market hierarchies are provided, for example grouped by region, sub-region, province or channel.

The product dimension can be delivered down to the level of “article” (EAN) in different hierarchies. Examples can include but are not limited to:
Competitor hierarchy (Competitor, Brand, Sub-Brand, Product Line, others);
Product Category Hierarchy (Category, Sub-Category, Segment, others).

The actual organization of market research data in a database, can vary widely between sources, however. Thus in some cases a database of market research data may not deliver the product level information at all, but only an aggregated level (e.g., Sub-Brand or product category).

Or, in another example, the product level is not provided in all sub trees of the hierarchy, for example private labels of retailers are sometimes provided on an aggregated level only. By contrast, the sub trees of the manufacturers may be provided down to the product level.

Sometimes, no product hierarchy including parent-child relationships is provided at all. Instead, the database data includes a semantic product level classification (e.g., Brand, Sub-Brand, Usage, Item etc.)

The dimension of time for market research data may depend upon the country. For example in Germany, market research data might be provided monthly with a time granularity of weeks. However, this can be different for other countries. Thus market research data for Great Britain is provided in time series of 4-weekly data—13 times a year.

Examples of time granularities for reporting market research data include but are not limited to the following:
Weekly Monday start day
Weekly Sunday start day
Four weekly starting Mondays
Four weekly starting Sundays
Monthly according calendar
Monthly according 5-4-4 week pattern
Bimonthly odd (first month odd: January, March, . . . )
Bimonthly even (first month even: December, February, . . . )
Quarterly

In some cases, it is even possible for one source database to reflect multiple time granularities.

As evident from the above, a global department of a firm receiving market research data from a plurality of sources, may be challenged to select market research data relevant to global analysis, in a consistent way.

Accordingly, embodiments relate to systems and methods configured to consolidate market research data from a plurality of sources (e.g., regional providers) into a single data warehouse suited for global reporting purposes. Accordingly an engine is provided in communication with a plurality of underlying databases each comprising market research data. The databases comprise a time dimension, a market dimension, and a product dimension. The engine aggregates data of the individual market research databases into a consolidated database, by first identifying a pre-aggregated market total. Next, the engine selects and identifies single individual products relevant to the aggregated market research data. Finally, the engine checks that the sum of the selected products of the previous step is within a tolerance level of the pre-aggregated market total of the initial step. If the check fails, in an iterative manner the engine returns to alter the selected relevant products and performs the check step again. In this manner, master data relevant for global reporting may be selected in a single application.

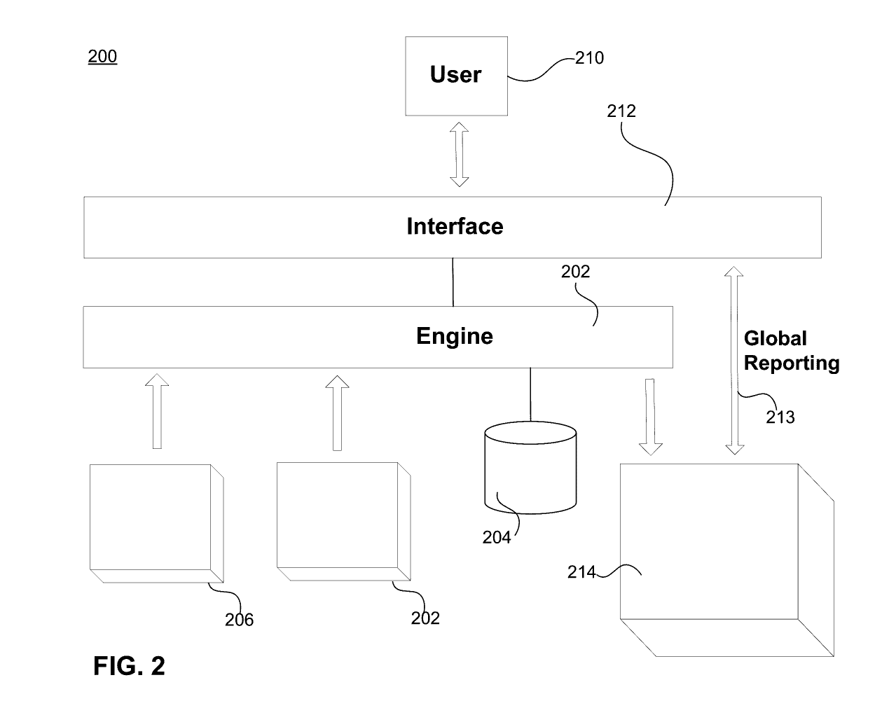

FIG. 2 is a simplified view of an embodiment of a data consolidation system according to an embodiment. The system 200 comprises a processing engine 202 that is in communication with a ruleset 204.

The processing engine is configured to receive data from a plurality of sources 206 and 208 of market resource information. These sources may comprise databases organized according to different structures. For example, source 206 may comprise market research data covering a first time period from a first region (e.g., Germany), while source 208 may comprise market research data covering a second time period from different region (e.g., the United States).

A user 210 seeks to consolidate the market research data from the plurality of sources 206, 208, into a single database 212 suitable for purposes of preparing global reports 213 (e.g., market data information including both Germany and the United States). Accordingly, the user interacts via interface 214, with the engine to perform a data consolidation process.

FIG. 3 is a simplified flow diagram showing a process 300 whereby an engine performs consolidation of market research data according to an embodiment. In a first step 302, market research data is received from a plurality of sources.

In a second step 304, the engine processes the market research data to calculate a pre-aggregated market total.

In a third step 306, the engine selects and identifies single products relevant to the aggregated market research data. In a fourth step 308, the engine checks to see whether the information calculated in the previous step, falls within a tolerance of the pre-aggregated market total.

If this check is satisfied, the consolidated market research data can be used for global reporting in the subsequent step 310.

If the check of step 308 is not satisfied, then the process returns to the previous step to allow identification and selection of different products. Thus in an iterative manner, a user may interact with disparate market research databases to create a consolidated database suitable for global reporting, whose products match a pre-aggregated market total.

As previously mentioned, one important aspect in which sources of market research data may differ, is with respect the time dimension. That is, different databases may include market research data collected over different time intervals.

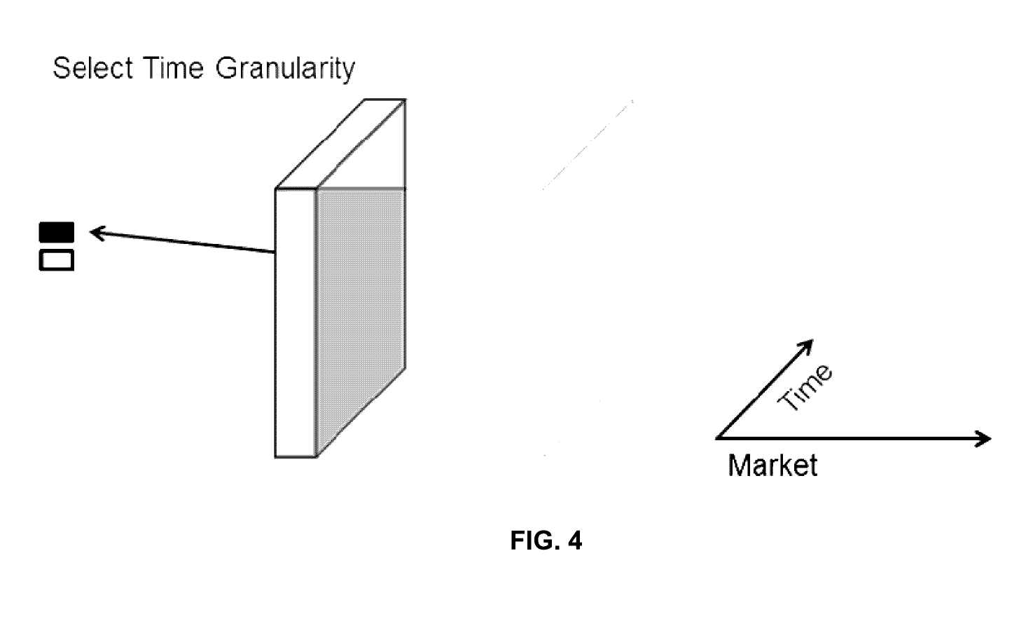

FIG. 4 is a simplified view showing the selection of granularity for the time dimension of a global market research database structure. The time dimension may be selected as follows.

To avoid double counting of numbers for purposes of global reporting, one time granularity is selected for global reporting. All other periods—if provided in exceptional cases—must get filtered out. If there is only one time granularity provided in the source data the system should automatically select that granularity.

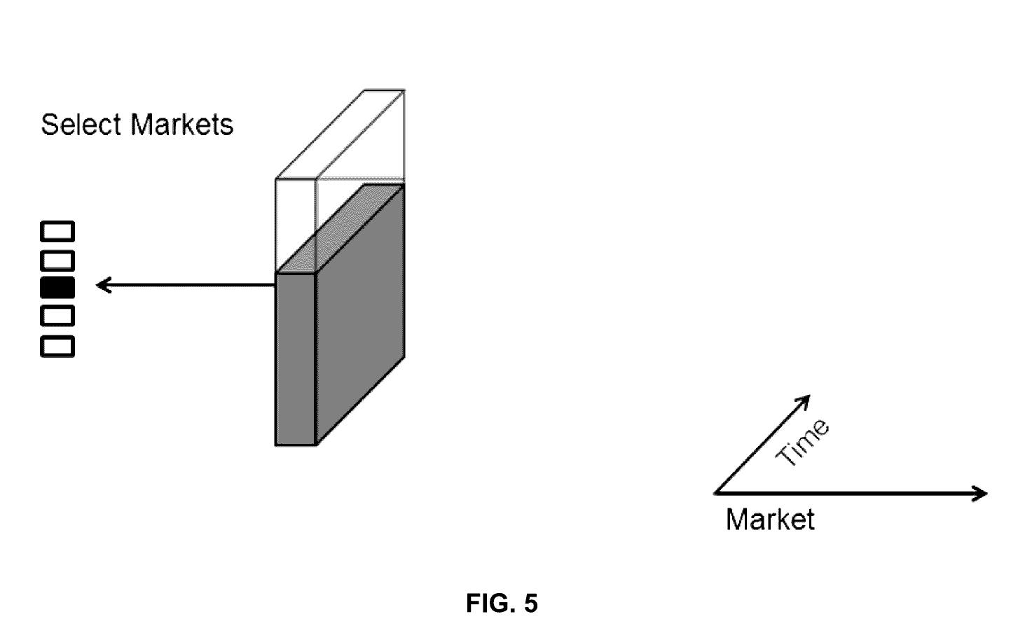

FIG. 5 is a simplified view showing the selection of markets for a global market research database structure. The market dimension may be selected as follows.

In global reporting, the focus is generally on the total market for a country. It must be possible to identify the total market out of all provided markets in the given database. Thus single values (e.g., a top node) may be selected.

Under some circumstances there may not be a single total market, but instead several markets to be combined to one market for global reporting. In such cases it should be possible to select multiple markets as well. In these cases, it may be possible to select 2-3 top nodes if there is no overall top market, but 2-3 single markets to be aggregated).

Rules may be defined for explicit key values, and/or rules may be defined based upon attributes (e.g., metadata associated with products and/or markets).

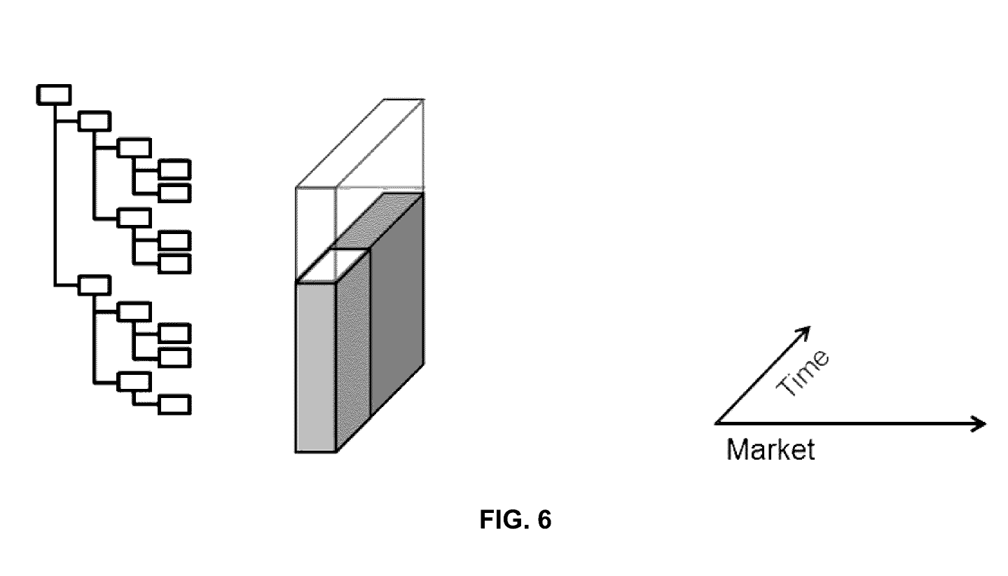

FIG. 6 is a simplified view showing the selection of products for a global market research database structure. The product dimension may be selected as follows.

For global reporting, typically the lowest level of the product hierarchy (the products) are used. This is especially true for the products of the manufacturer itself, and those of the most important global competitors.

However, it should be possible to select products and/or nodes of a product hierarchy for a global layer as well. For example, a system may allow for selecting parts of the product hierarchy that do not go to the lowest hierarchy level (as mentioned above aggregated nodes for private labels).

In any case, the sum of the selected products should fit to the total number (the top node of the product hierarchy) provided by the market research provider. This is not necessarily to 100% the exactly the same value, as the total numbers for the different nodes are provided as so-called pre-aggregated totals by the market research company.

Exactly how this value is calculated is not known, as it is not necessarily the sum of all underlying nodes or leaves of the hierarchy. Therefore, it should be possible to define a tolerance within the sum of the selected products is equal to the pre-aggregated total.

Selecting products may be done using simple rules. Rules can be defined using keys and/or attributes. For example, the rule could be “take all products that have hierarchy level 8 and additionally take the product with ID 0815 (because that product is on level 3 and has no children in the hierarchy)”.

This would allow that the rules are not changed for any new delivery, if new products are provided. In an example, all new products on level 8 will be accepted as well, but new childless products of level 3 will not). But if changes in a new delivery would require an adjustment of the rules, the user is notified.

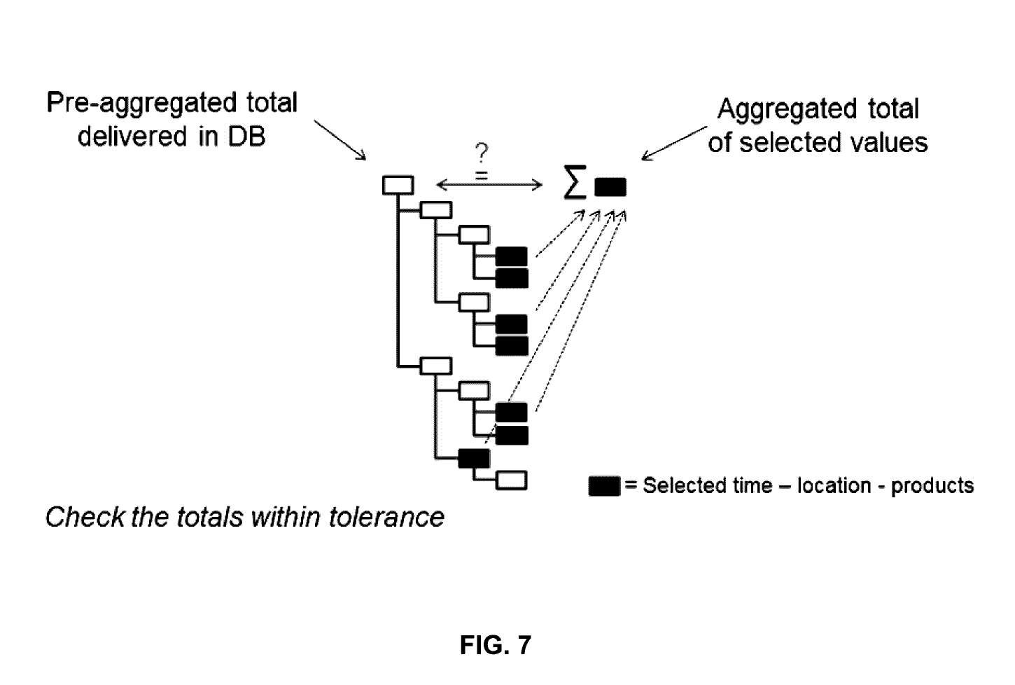

There should therefore be a check in place not only when rules are defined, but also during the data upload. This check proves whether the sum of selected products of the current delivery continue to fit the pre-aggregated total within the defined tolerance. FIG. 7 is a simplified view showing checking of values within a tolerance level.

As mentioned above, global reporting typically selects all products on the lowest level of one product hierarchy. The sum of the products will be the major part compared to pre-aggregated total value. One main challenge is to identify the products that contribute to the total as well but are not available on the lowest level.

In addition, it is desirable to guide the user so that selection can be accomplished efficiently in a short time frame, based upon a single application.

Further details regarding market data research consolidation according to various embodiments, are now provided in connection with the following specific example.

### EXAMPLE

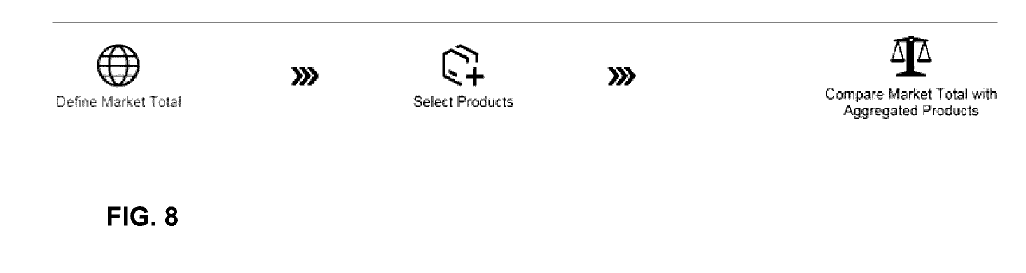

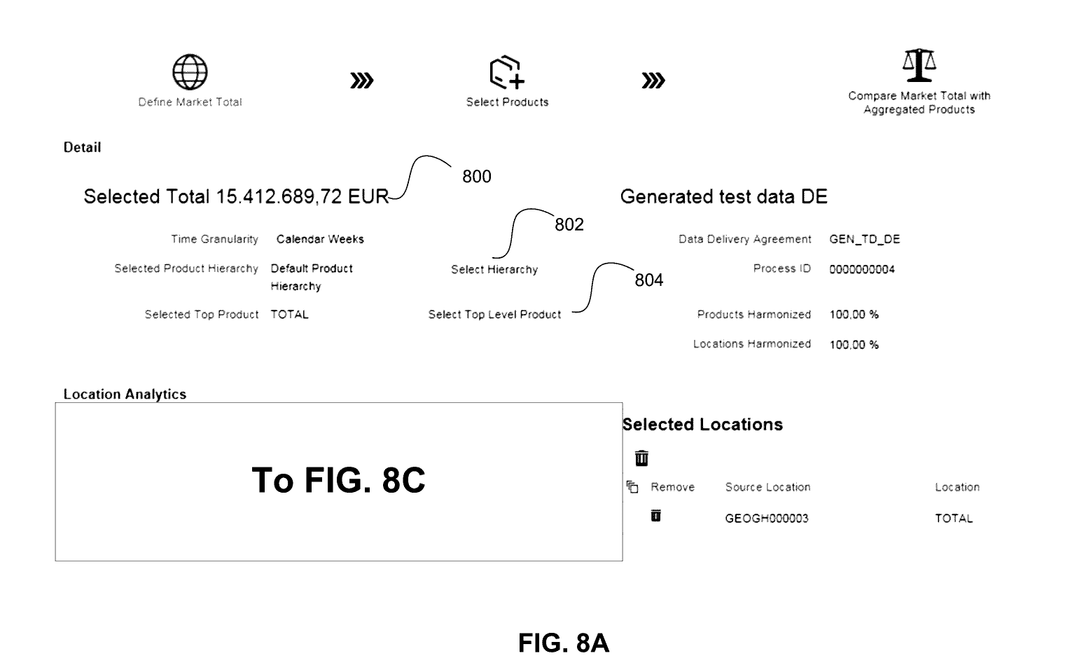

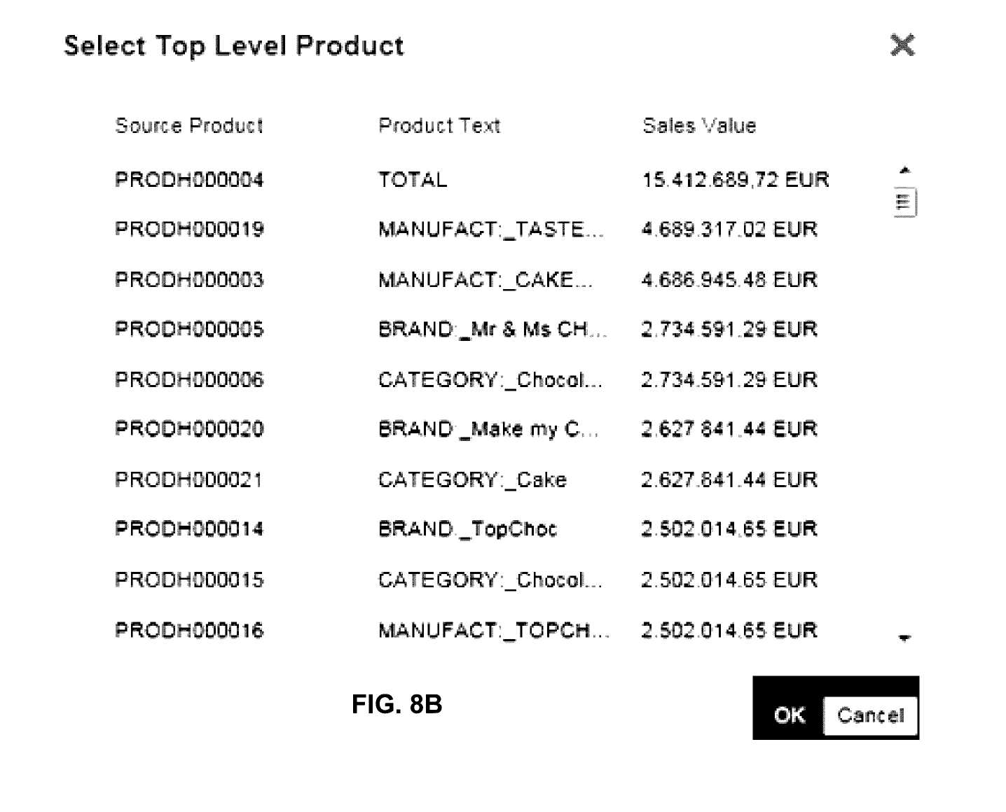

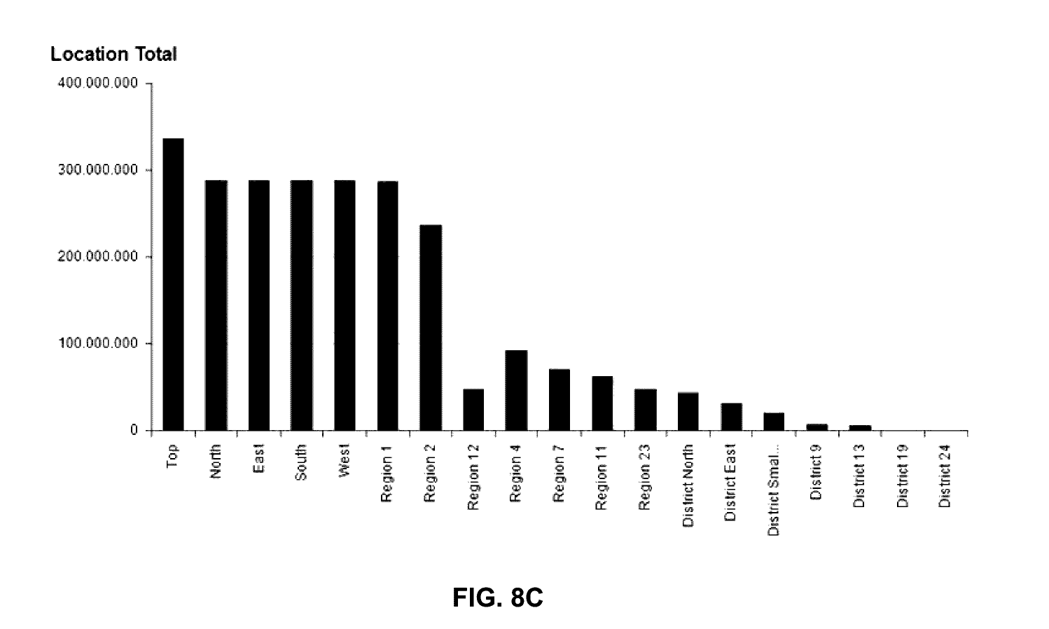

One example of data consolidation according to an embodiment, is now presented in connection with the screenshots shown in FIGS. 8-10A. In particular, FIG. 8 is a header of a series of screenshots illustrating an overall process flow for data consolidation according to an example.

As described in detail above, this header shows the steps of: defining a total market, selecting products, and comparing the defined market total with aggregated products. The remaining FIGS. 8A-10A show screenshots illustrating performance of these various steps.

For example, FIG. 8A is a screenshot showing selection of a pre-aggregated market total according to the example. The screenshot of this figure allows easy identification of pre-aggregated market total based on analytics.

Panel 800 of FIG. 8A allows automatic selection of time granularity. In certain embodiments this time granularity may be pre-selected by the system.

Panel 802 of FIG. 8A allows selecting a hierarchy (if available) as pre-selection for top product. FIG. 8B is a screenshot showing definition of a product hierarchy according to the example. This allows easy selection of a top level product by providing a sorted analytics.

Panel 804 of FIG. 8A shows easy selection of the top product. FIG. 8C is a screenshot providing a chart/analytics of the Top-selling markets. Multiple markets may be selected if necessary, with the follow product consolidation definition performed for each.

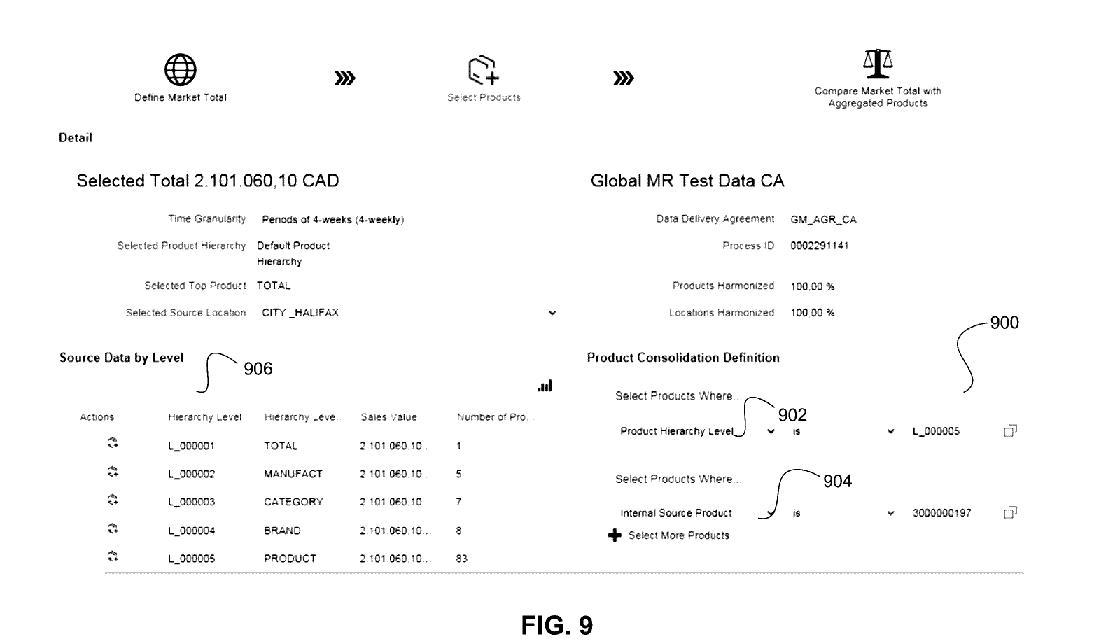

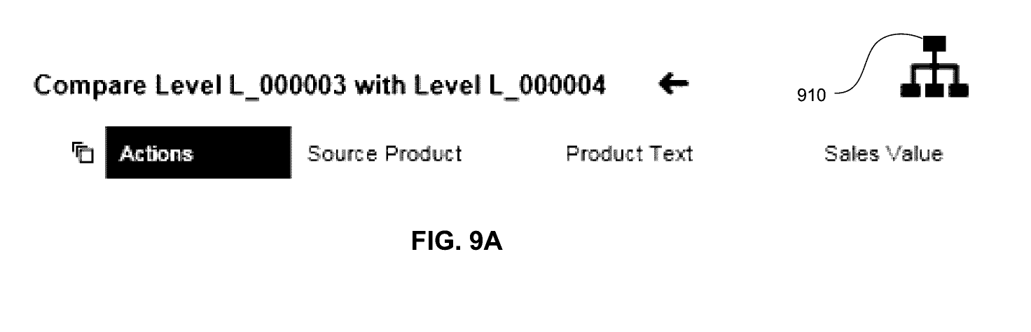

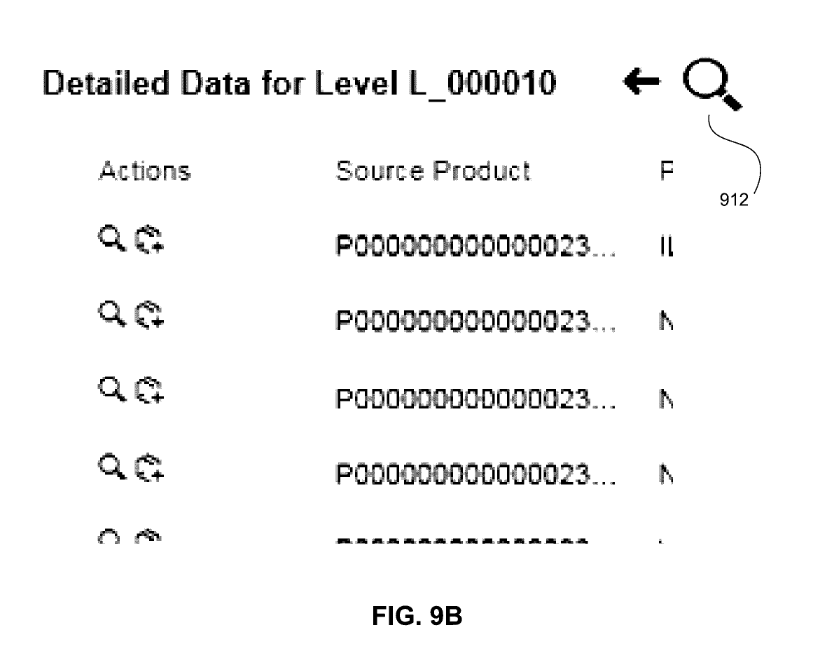

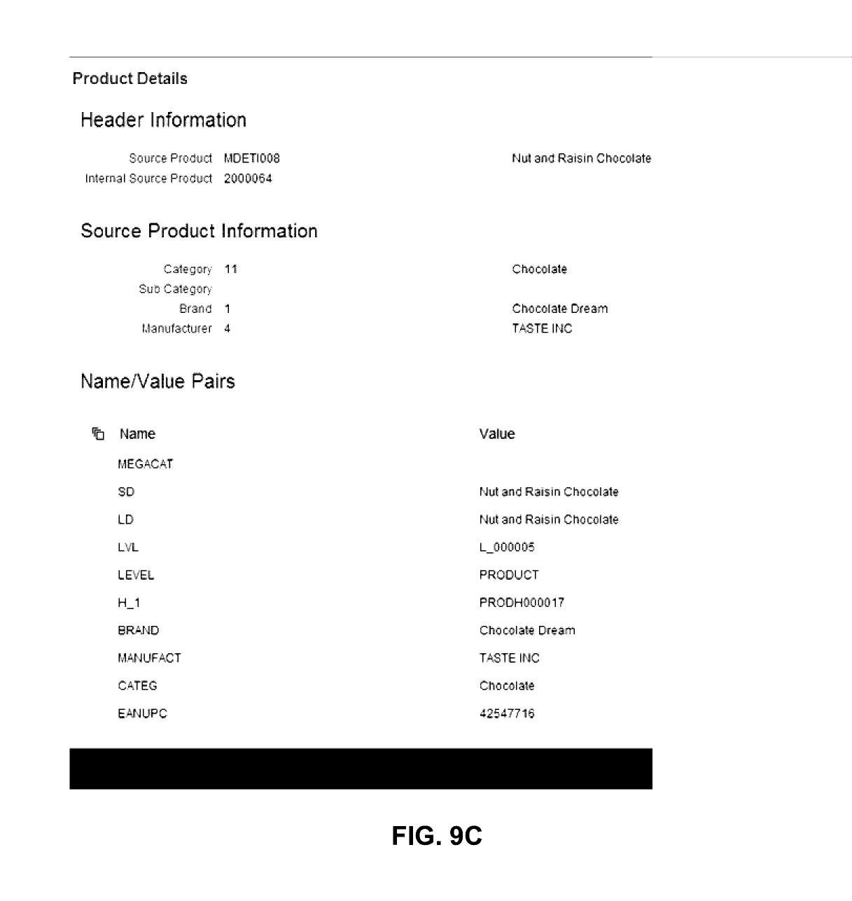

Specifically, FIG. 9 is a screenshot showing product consolidation definition according to the example. This display allows simple selection and identification of all relevant single products.

In particular, products can be identified based on hierarchical and semantic product level analysis. A next level check can be provided that identifies missing products.

This screen also supports product determination with attribute analysis of products. It allows a number of products per level analysis for indicating gaps or inconsistencies in levels.

Panel 900 of FIG. 9 allows selection of products by defining rules. Selection box 902 defines a rule for selecting a product by attribute. Selection box 904 defines a rule for selecting a product by key.

Panel 906 shows Analysis of source data by level. FIG. 9A is a screenshot showing comparison to a hierarchy level to identify products with no nodes on lower levels. This screen may be accessed by clicking on the icon 910 in the panel 902.

FIG. 9B is a screenshot showing detailed data for a particular level according to the example. This screen may be accessed by clicking on the icon 912 in the panel 902. Further clicking on this icon in the screen of FIG. 9B produces the screenshot of FIG. 9C displaying source data by level.

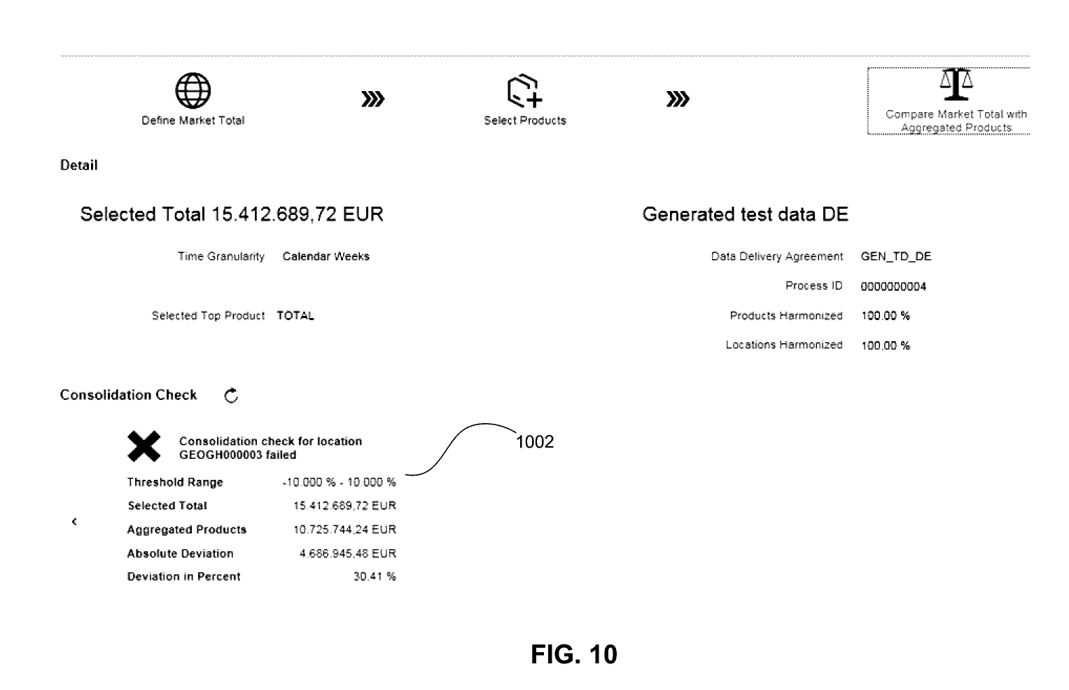

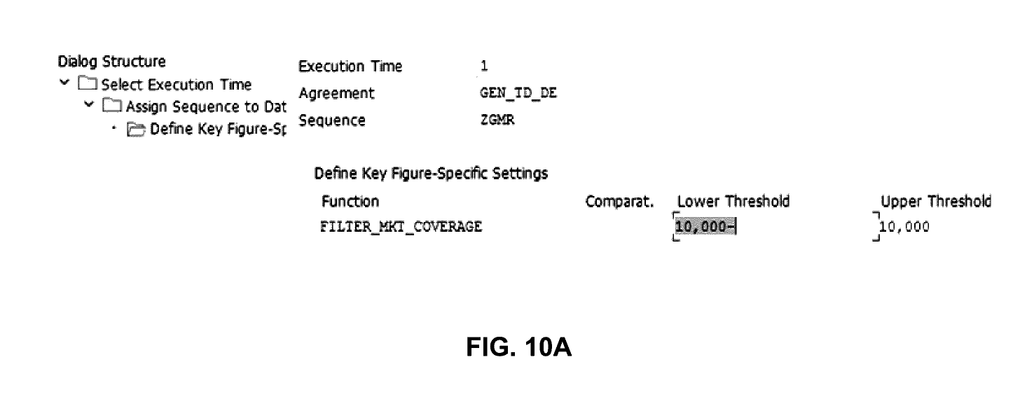

FIG. 10 is a screenshot of the final step in the data consolidation process flow according to the example. Here, a market total is compared with aggregated totals.

Specifically, this step allows for the final check identifying gaps between market total and consolidated product total. It provides for the possibility of defining tolerances for checking in each database

This check may be executed in the definition of the consolidation and during run time of data upload. This check may be executed for each selected market (if multiple markets are allowed).

This screen allows adjusting the consolidation definition if necessary. Thus as panel 1002 of FIG. 10 shows a Threshold Range defined in the transaction: “Configure Quality Validation“-”Before Data Extraction to Global Reporting”. FIG. 10A is a screenshot showing adjustment of that threshold range before data extraction to global reporting.

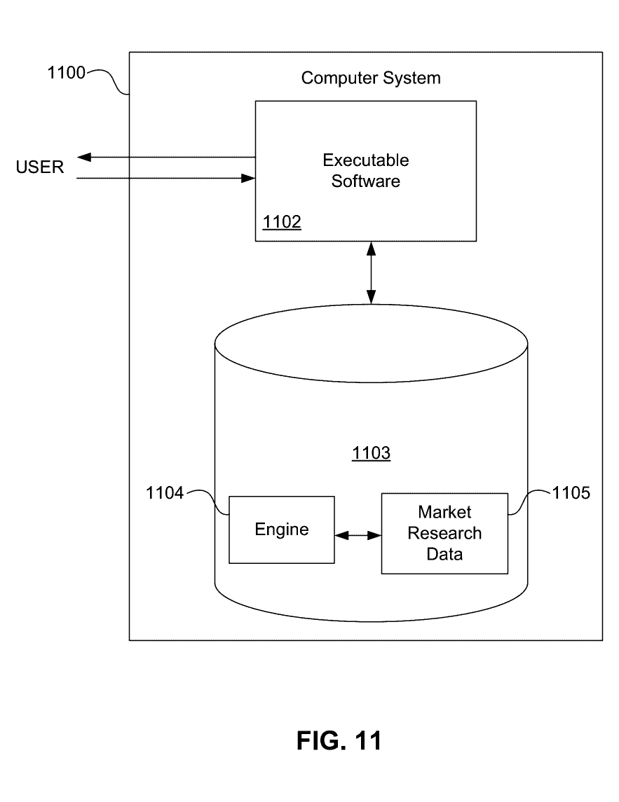

FIG. 11 illustrates hardware of a special purpose computing machine configured to perform data consolidation according to an embodiment. In particular, computer system 1101 comprises a processor 1102 that is in electronic communication with a non-transitory computer-readable storage medium 1103. This computer-readable storage medium has stored thereon code 1105 corresponding to market research data. Code 1104 corresponds to an engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

It is noted that in the specific embodiment of FIG. 11, the engine is shown as being part of the database. Such an embodiment can correspond to applications where processing is performed by a powerful engine available as part of an in-memory database (e.g., the HANA in-memory database available from SAP SE of Walldorf, Germany. However this is not required and in certain embodiments the engine may be implemented in other ways, for example as part of an overlying application layer.

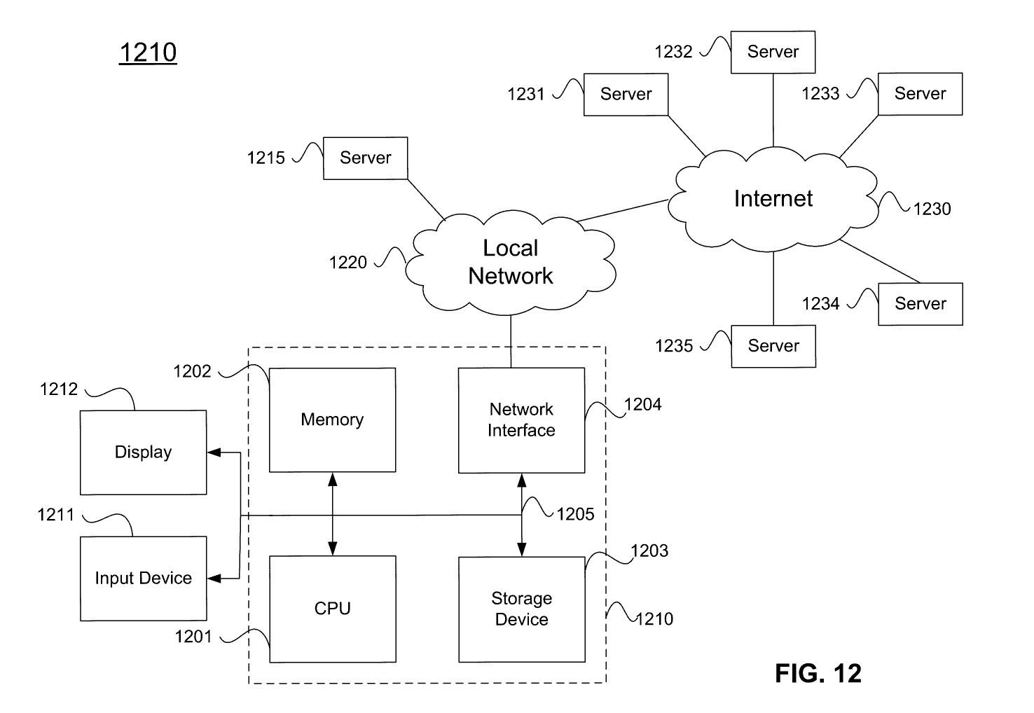

An example computer system 12 is illustrated in FIG. 12. Computer system 1210 includes a bus 1205 or other communication mechanism for communicating information, and a processor 1201 coupled with bus 1205 for processing information. Computer system 1210 also includes a memory 1202 coupled to bus 1205 for storing information and instructions to be executed by processor 1201, including information and instructions for performing the techniques described above, for example. This memory may also be used for storing variables or other intermediate information during execution of instructions to be executed by processor 1201. Possible implementations of this memory may be, but are not limited to, random access memory (RAM), read only memory (ROM), or both. A storage device 1203 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1203 may include source code, binary code, or software files for performing the techniques above, for example. Storage device and memory are both examples of computer readable mediums.

Computer system 1210 may be coupled via bus 1205 to a display 1212, such as a cathode ray tube (CRT) or liquid crystal display (LCD), for displaying information to a computer user. An input device 1211 such as a keyboard and/or mouse is coupled to bus 1205 for communicating information and command selections from the user to processor 1201. The combination of these components allows the user to communicate with the system. In some systems, bus 1205 may be divided into multiple specialized buses.

Computer system 1210 also includes a network interface 1204 coupled with bus 1205. Network interface 1204 may provide two-way data communication between computer system 1210 and the local network 1220. The network interface 1204 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1204 sends and receives electrical, electromagnetic, or optical signals that carry digital data streams representing various types of information.

Computer system 1210 can send and receive information, including messages or other interface actions, through the network interface 1204 across a local network 1220, an Intranet, or the Internet 1230. For a local network, computer system 1210 may communicate with a plurality of other computer machines, such as server 1215. Accordingly, computer system 1210 and server computer systems represented by server 1215 may form a cloud computing network, which may be programmed with processes described herein. In the Internet example, software components or services may reside on multiple different computer systems 1210 or servers 1231-1235 across the network. The processes described above may be implemented on one or more servers, for example. A server 1231 may transmit actions or messages from one component, through Internet 1230, local network 1220, and network interface 1204 to a component on computer system 1210. The software components and processes described above may be implemented on any computer system and send and/or receive information across a network, for example.

In conclusion, it is noted that methods and systems configured to perform consolidation of market research data according to various embodiments, may offer one or more benefits. One potential advantage is the ability to easily select the master data relevant for global reporting in a short time frame, integrated within a single application.

The user may be guided and supported by the system to make correct decisions and accurate selections.

Embodiments may provide checks during a definition phase of the consolidation process, uploading data according to user settings. This helps to ensure use of the appropriate data for global reporting, without requiring manual verification of the data selection for each data delivery (which could be several hundred per month).

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
an engine receiving first market research data from a first source, and receiving second market research data from second source;
the engine calculating a pre-aggregated market total from the first market research data and the second market research data;
the engine generating from the first market data and the second market data, a first aggregated market total comprising a first selected product in the first market research data and the second market research data;
the engine determining whether the first aggregated market total is within a tolerance of the pre-aggregated market total;
the engine displaying to a user, a result of the determining;
where the aggregated market total is within the tolerance, displaying a global report to the user; and
where the aggregated market total is not within the tolerance, the engine,
generating from the first market data and the second market data, a second
aggregated market total comprising a second selected product, and
the engine determining whether the second aggregated market total is within the tolerance.

2. A method as in claim 1 wherein the second aggregated market total further comprises the first selected product.

3. A method as in claim 1 wherein the second aggregated market total does not comprise the second selected product.

4. A method as in claim 1 wherein the pre-aggregated market total and the first aggregated market total are calculated according to a common time granularity input by the user.

5. A method as in claim 1 wherein the tolerance is input to the engine from the user.

6. A method as in claim 1 wherein the pre-aggregated market total and the first aggregated market total are calculated according to a market segment of the first market research data.

7. A method as in claim 1 wherein the first selected product is from a product hierarchy of the first market research data.

8. A method as in claim 7 wherein the global report includes the product hierarchy.

9. A method as in claim 1 further comprising displaying the global report when the second aggregated market total is within the tolerance.

10. A method as in claim 1 further comprising calculating a third aggregated market total comprising a third product where the second aggregated market total is not within the tolerance.

11. A non-transitory computer readable storage medium embodying a computer program for performing a method, said method comprising:
an engine receiving first market research data from a first source, and receiving second market research data from second source;
the engine calculating a pre-aggregated market total from the first market research data and the second market research data;
the engine generating from the first market data and the second market data according to a time granularity, a first aggregated market total comprising a first selected product in the first market research data and the second market research data;
the engine determining whether the first aggregated market total is within a tolerance of the pre-aggregated market total;
the engine displaying to a user, a result of the determining;
where the aggregated market total is within the tolerance, displaying a global report to the user; and
where the aggregated market total is not within the tolerance, the engine,
generating from the first market data and the second market data, a second
aggregated market total comprising a second selected product, and
the engine determining whether the second aggregated market total is within the tolerance.

12. A non-transitory computer readable storage medium as in claim 11 wherein the second aggregated market total further comprises the first selected product.

13. A non-transitory computer readable storage medium as in claim 11 wherein the second aggregated market total does not comprise the first selected product.

14. A non-transitory computer readable storage medium as in claim 11 wherein the pre-aggregated market total and the first aggregated market total are calculated according to a market segment of the first market research data.

15. A non-transitory computer readable storage medium as in claim 11 wherein the first selected product is from a product hierarchy of the first market research data.

16. A non-transitory computer readable storage medium as in claim 11 further comprising:
the engine displaying the global report when the second aggregated market total is within the tolerance;
the engine generate a third aggregated market total comprising a third product where the second aggregated market total is not within the tolerance.

17. A computer system comprising:
one or more processors;
a software program, executable on said computer system, the software program configured to cause an engine to:
receive first market research data from a first source, and receive second market research data from second source;
calculate a pre-aggregated market total from the first market research data and the second market research data;
generate from the first market data and the second market data, a first aggregated market total comprising a first selected product of the first market research data and the second market research data;
determine whether the first aggregated market total is within a tolerance of the pre-aggregated market total;
display to a user, a result of the determining;
where the aggregated market total is within the tolerance, display a global report to the user; and
where the aggregated market total is not within the tolerance,
generate from the first market data and the second market data, a second
aggregated market total comprising at least a second selected product, and
determine whether the second aggregated market total is within the tolerance.

18. A computer system as in claim 17 wherein the software program is further configured to cause the engine to calculate the pre-aggregated market total and the first aggregated market total according to a market segment of the first market research data.

19. A computer system as in claim 17 wherein the software program is further configured to cause the engine to calculate the first aggregated market total according to the first selected product from a product hierarchy of the first market research data.

20. A computer system as in claim 17 wherein the software program is configured to further cause the engine to,
display the global report when the second aggregated market total is within the tolerance; and
generate a third aggregated market total comprising a third product where the second aggregated market total is not within the tolerance.
